(19) United States
(12) Patent Application Publication
(10) Pub. No.: US 2024/0346617 A1
(43) Pub. Date: Oct. 17, 2024

(54) METHOD FOR DISPLAYING CONTENT ACCESSIBLE TO SCREEN READERS

(71) Applicant: Be More Colorful, LLC, Fargo, ND (US)

(72) Inventor: Matthew Chaussee, Fargo, ND (US)

(73) Assignee: Be More Colorful, LLC, Fargo, ND (US)

(21) Appl. No.: 18/632,125

(22) Filed: Apr. 10, 2024

Related U.S. Application Data
(60) Provisional application No. 63/495,371, filed on Apr. 11, 2023.

(51) Int. Cl. G06T 3/06

(52) U.S. Cl. CPC G06T 3/06; G06T 2200/24

(57) ABSTRACT

A method for displaying content accessible to screen readers includes extracting a multiple of still images from a 360-degree image to form a cube of images; and unwrapping the cube of images into a cross image to render the image readable by a screen reader.

### CROSS-REFERENCE TO RELATED APPLICATIONS

The present disclosure claims priority to U.S. Provisional Patent Disclosure Ser. No. 63/495,371 filed Apr. 11, 2023.

### BACKGROUND

The present disclosure relates to a method for displaying content accessible to screen readers.

Digital cameras with 360-degree capabilities have been used for both taking still photos and videos. The 360-degree photos and videos are created using a combination of multiple panoramic images, photospheric images, or videos captured using an omnidirectional camera. These images are then stitched together to form a contiguous spherical or semispherical image orthogonally positioned to an interactive viewport within a user interface.

Virtual reality, augmented reality, interactive displays, are various examples of immersive environments. Images taken in a 360-degree format require additional processing to place into a format that provides immersive environments. Immersive environments may be used in educational settings; however, such immersive environments are not compatible with visual screen readers which assist the visually impaired by audibly reading text on a screen.

### BRIEF DESCRIPTION OF DRAWINGS

Various features will become apparent to those skilled in the art from the following detailed description of the disclosed non-limiting embodiment. The drawings that accompany the detailed description can be briefly described as follows:

FIG. 1 is a schematic block diagram of a method for displaying content in a way that is accessible to screen readers according to one disclosed non-limiting embodiment.

FIG. 2 is a schematic view of an example spherical image with hotspots thereon.

FIG. 3A is a schematic view of a cube of images unwrapped from the spherical image into an example horizontal “T” shape image according to the method.

FIG. 3B. is a pictorial view of a cube of images unwrapped into the horizontal “T” shape image.

FIG. 4A is a schematic view of a cube of images unwrapped from the spherical image into an example horizontal cross shape image according to the method.

FIG. 4B is a pictorial view of a cube of images unwrapped into the horizontal cross shape image.

### SUMMARY

A method for displaying content accessible to screen readers according to one disclosed non-limiting embodiment of the present disclosure includes extracting a multiple of still images from a 360-degree image to form a cube of images; and unwrapping the cube of images into a cross image to render the image readable by a screen reader.

A further embodiment of any of the foregoing embodiments of the present disclosure includes that the cross image is a horizontal cross image.

A further embodiment of any of the foregoing embodiments of the present disclosure includes that the cross image is a vertical cross image.

A further embodiment of any of the foregoing embodiments of the present disclosure includes that adding html elements onto each separate images of the cross image.

A further embodiment of any of the foregoing embodiments of the present disclosure includes that remapping of the images from the 360-degree image to the cross image.

A further embodiment of any of the foregoing embodiments of the present disclosure includes that the cube of images comprises six (6) images.

A method for displaying content accessible to screen readers according to one disclosed non-limiting embodiment of the present disclosure includes extracting a multiple of still images from a 360-degree image to form a cube of images; unwrapping the cube of images into a cross image to render the image readable by a screen reader; deconstructed the cube of images into separate images each of which are renamed with their associated label, the center image of the cube images corresponding with a center of the 360-degree image; and adding html elements onto each separate image of the cross image at a fixed orientation.

A further embodiment of any of the foregoing embodiments of the present disclosure includes that the most important subject is selected as the center of the 360-degree image and set as the center of the cube of images.

A further embodiment of any of the foregoing embodiments of the present disclosure includes that the cross image is a horizontal cross image.

A further embodiment of any of the foregoing embodiments of the present disclosure includes that the cross image is a vertical cross image.

A further embodiment of any of the foregoing embodiments of the present disclosure includes that unwrapping the cube of images into the cross image comprises mapping latitude/longitude coordinates from the equirectangular image to the cross image.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### DETAILED DESCRIPTION

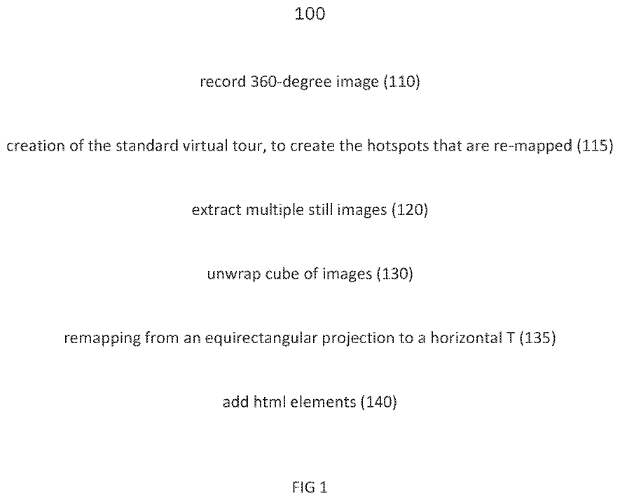

FIG. 1 schematically illustrates a method 100 for displaying content in a way that is accessible to screen readers. Screen readers are software programs that allow blind or visually impaired users to read the text that is displayed on the computer screen with a speech synthesizer or braille display. Screen readers may also read alt text, describe links, and allow the user to interact with html elements on a webpage. A screen reader is the interface between the computer's operating system, its applications, and the user.

The method 100 is disclosed in terms of functional block diagrams. It should be appreciated that these functions may be enacted in either dedicated hardware circuitry or programmed software routines capable of execution in various microprocessor-based electronics control embodiments.

Initially, a 360-degree image is recorded (110). The 360-degree image may include video and/or a 360-degree photo. The type of camera which could be used for the disclosed method may include any 360-degree photo and video capture device. Typically, such a device is a single device with multiple lenses allowing for everything from the camera's perspective to be captured. Alternatively, a single device may be panned around manually or automatically to capture the 360-degree image. A 360-degree video capture device may be used to also shoot the 360-degree photo. A video capture device may perform the recording. For example, the video capture device may simultaneously both shoot and record images. A still-frame photo may alternatively or additionally be taken from the 360-degree video.

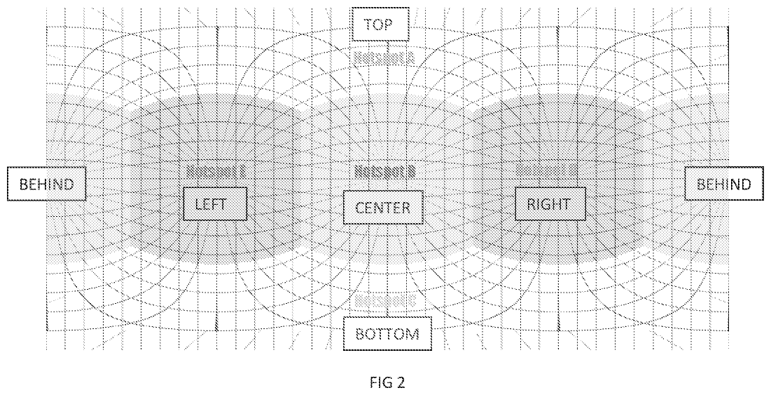

The finished “equirectangular” 360-degree images are uploaded to a virtual tour platform where html elements are added to enhance the content, e.g., “hotspots” or points of interest that are mapped to a particular position on the 360 image and when clicked or tapped, allow a viewer to display content such as text, photos, or videos (115; FIG. 2). This is the traditional virtual tour format that is not accessible to screen readers.

A hotspot or point of interest is a selectable space of content in the interactive environment. The point of interest is at a location that will be accessed by viewers in the interactive environment. The frame of action may provide a pop-out window or content beyond the point of interest. The frame of action may provide text, images, videos, or allows the viewer to learn more about a given part of the interactive environment. A frame of action may be used to provide more information about content communicated in the interactive environment. For example, additional information on the day-to-day items, tools, machinery, or environment a worker is inhabiting may be provided. For example, suppose the method to use a camera is configured for the purpose of providing a career experience to a viewer. In that case, the hotspots may help strengthen the viewer's understanding of what the job environment provides and what prerequisites the viewer may need to succeed in a given career field. The hotspots may also help build the environment with facts about the location, the company, and the developments or practices a company may value. The operator may determine the hotspots.

Next, a multiple of still images are extracted (120) from the 360-degree image to form a cube of images. That is, the image sphere is converted to an image cube. In one embodiment, six (6) images are extracted. The six (6) images may represent, for example, Center, Left, Right, Top, Bottom, Behind.

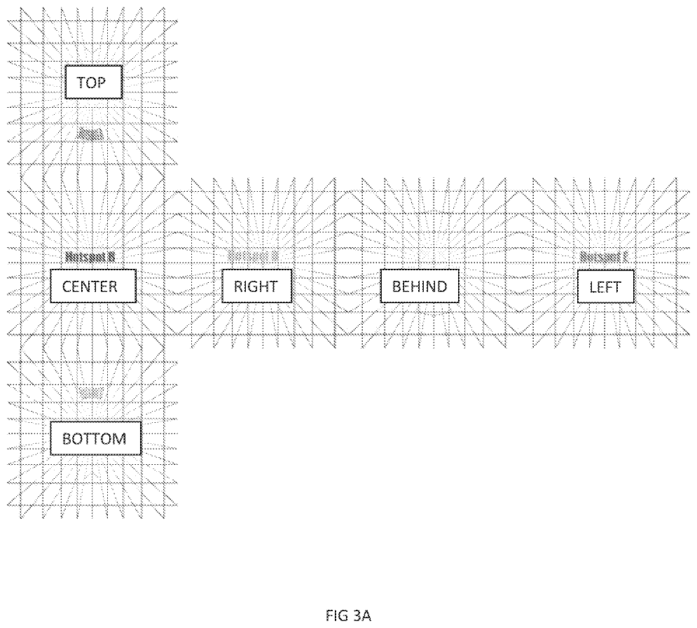

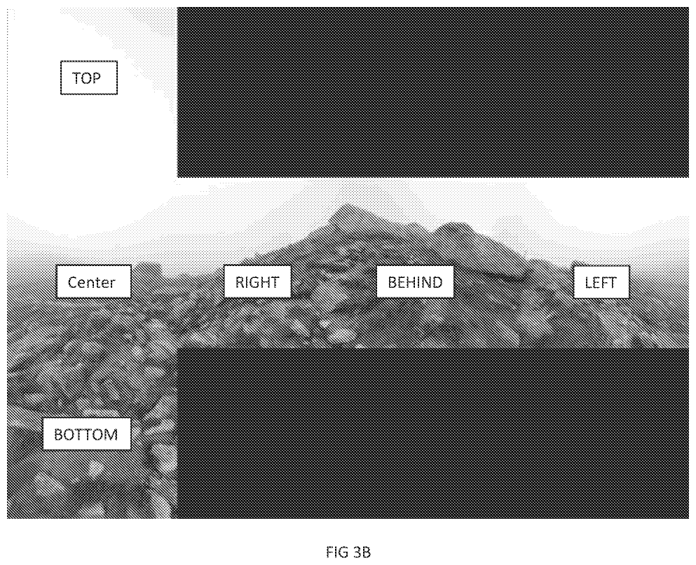

Next, the cube of images is unwrapped (130) into a flat image, for example, a horizontal “T” shape image (FIG. 3A and 3B), a vertical “T” shape image, a horizontal cross image or a vertical cross image, etc. In one example, the flat image is unwrapped with the vertical “panning” on the left-hand side and the horizontal “panning” with the central square on the left. The flat image is an image type which can optionally be loaded into a virtual tour software such as, for example only, Pano2VR. The previous format can alternatively or additionally be uploaded to a virtual tour software application. Virtual tour software converts 360-degree imagery into interactive experiences. By performing the disclosed method, the interactive experiences can display content in a way that is accessible to screen readers.

The individual scenes from the virtual tour above are then processed and reconverted into a format where the image is flattened to, for example, a horizontal “T” shape image, and the points of interest are remapped to their new positions on the static image (135). Removal of rotation, flattening of the image, and re-positioning the hotspots on their new positions make these accessible to screen readers. That is, the hotspots may be mapped to the deconstructed images so as to be accessed by the screen reader. Each individual scene in the virtual tour is then remapped. In one example, the “cross” or horizontal “T” shape is deconstructed into separate images each of which are renamed with an associated label (e.g., top, bottom, left, right, center, behind). In another example, a virtual tour with ten (10) 360-degree images would have ten (10) horizontal “T” shape images and appropriate labels. The most important subject may be determined along the center of the spherical panorama and set subject to be the center of the spherical image, then with that fixed as the orientation, a cube mapping such as a horizontal “T” as updated in the diagram is performed.

Optionally, or in addition, html elements may be added (140) onto the flat image to render the flat image readable by a visual screen reader. For example, screen readers require a fixed orientation to read html elements on a page. When viewed in an interactive viewer, a screen reader has no way of knowing what is left and what is right because on a sphere, one can navigate to any two points with multiple directions of rotation. By flattening the image as the horizontal “T” shape as described above, an image is created that can readily be displayed as a background on a static webpage.

Optionally, or in addition, additional metadata fields of alternate text describing each “face” of the cube may be provided, e.g. “at center is a man wearing a hat”, “at the top you see a blue sky with clouds”, “at the bottom you see the man's feet wearing cowboy boots on a dirt floor”, “to the right you see another man wearing a hat holding a pitchfork”, “behind you is a row of farm tools”, “to your left is a tractor”, etc. The text metadata fields may be incorporated into each of the corresponding images at a fixed orientation so that the screen reader can read such data.

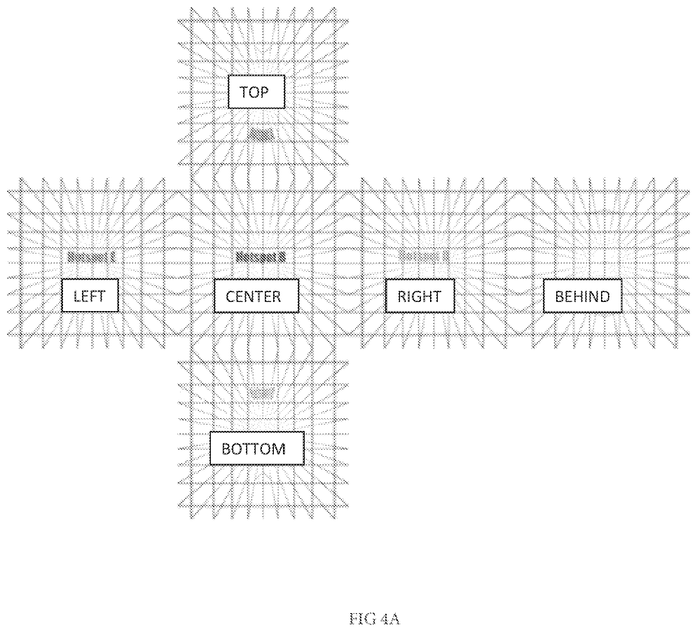

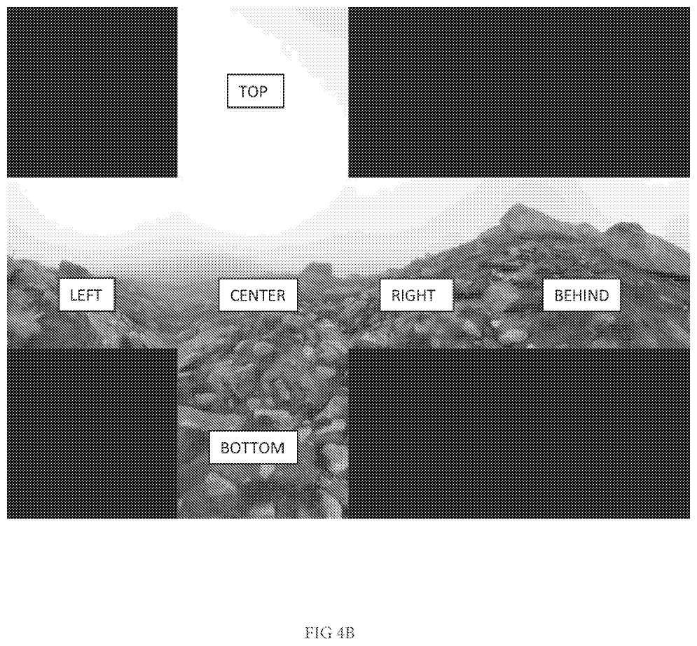

All of the interactive elements that were displayed on the spherical image are thereby remapped to their corresponding positions on the flattened “T” image which in one embodiment, involves mapping latitude/longitude coordinates from an equirectangular image to a cross (FIG. 4A, 4B).

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed is:

1. A method for displaying content accessible to screen readers, comprising:
extracting a multiple of still images from a 360-degree image to form a cube of images; and
unwrapping the cube of images into a cross image to render the image readable by a screen reader.

2. The method as recited in claim 1, wherein the cross image is a horizontal cross image.

3. The method as recited in claim 1, wherein the cross image is a vertical cross image.

4. The method as recited in claim 1, further comprising adding html elements onto each separate image of the cross image.

5. The method as recited in claim 1, further comprising remapping of the images from the 360-degree image to the cross image.

6. The method as recited in claim 1, wherein the cube of images comprises six (6) images.

7. A method for displaying content accessible to screen readers, comprising:
extracting a multiple of still images from a 360-degree image to form a cube of images;
unwrapping the cube of images into a cross image to render the image readable by a screen reader;
deconstructing the cube of images into separate images each of which are renamed with their associated label, the center image of the cube images corresponding with a center of the 360-degree image; and
adding html elements onto each separate image of the cross image at a fixed orientation.

8. The method as recited in claim 7, wherein the most important subject is selected as the center of the 360-degree image and set as the center of the cube of images.

9. The method as recited in claim 8, wherein the cross image is a horizontal cross image.

10. The method as recited in claim 8, wherein the cross image is a vertical cross image.

11. The method as recited in claim 8, wherein unwrapping the cube of images into the cross image comprises mapping latitude/longitude coordinates from the equirectangular image to the cross image.
